(19) United States
(12) Patent Application Publication
(10) Pub. No.: US 2018/0158219 A1
(43) Pub. Date: Jun. 7, 2018

(54) TRACING CANVAS

(71) Applicant: Luis Javier PAGAN, Dublin, OH (US)

(72) Inventor: Luis Javier PAGAN, Dublin, OH (US)

(21) Appl. No.: 15/849,826

(22) Filed: Dec. 21, 2017

Related U.S. Application Data
(60) Provisional application No. 62/506,162, filed on May 15, 2017.

(51) Int. Cl. G06T 11/20; G06T 11/00; G06T 11/60; G06F 3/0484; G06F 3/0482

(52) U.S. Cl. CPC G06T 11/203; G06T 11/001; G06F 3/0482; G06F 3/04847; G06T 11/60

(57) ABSTRACT

A graphical user interface (GUI) for a drafting software configured to run on a computer system including a display on which the GUI is displayed may include a window including a drawing canvas configured to receive and display thereon user drawing input and further configured to be made transparent or semi-transparent such that at least a portion of a background or second window above which the window overlays is visible through the drawing canvas.

### BACKGROUND

Computer Aided Design (CAD) applications allow a user to create and edit drawings on a computer display. CAD software usually includes a work surface commonly known as a canvas or paper space that resembles a drawing canvas on which a user may draw. CAD software receives and displays on the canvas user drawing input such as, for example, user drawing input entered by a user by using a mouse, a drawing pen on the computer screen, etc. Such drawing canvas are also known as design space, drawing space, model space, paper space, etc.

Conventionally, such canvas are of a color that provides contrast with the drawing. A common setup is, for example, a white canvas on which a black drawing may be entered and displayed. Conventionally, canvas may be set to different colors such as white, black, and every other color in between. But they are conventionally opaque.

### SUMMARY OF THE INVENTION

Opaque canvasses limit a user's ability to accurately draw figures or graphics also displayed on a computer screen together with the CAD canvas. Because prior art canvasses are opaque, other windows or backgrounds that are behind the canvas cannot be seen through the canvas. This creates the problem that a user may not easily trace on the canvas figures or graphics displayed behind the canvas.

The present disclosure provides a drawing canvas that may be made transparent or semi-transparent such that at least a portion of a background or second window above which the canvas overlays is visible through the drawing canvas. This way a user may easily trace on the canvas figures or graphics displayed behind the canvas.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates an exemplary graphical user interface.

FIG. 2 illustrates a prior art CAD canvas which is opaque and thus what is behind it cannot be seen.

FIG. 3 illustrates an exemplary prior art menu on which the CAD canvas may not be specified to be set to semi-transparent or transparent.

FIG. 4 illustrates an exemplary blank opaque canvas.

FIG. 5 illustrates an exemplary semi-transparent canvas.

FIG. 6 illustrates an exemplary drawing a user has made on the CAD canvas by tracing the outside shape of one of the automobile pictures and tree picture, which can be seen through the semi-transparent canvas.

FIG. 7 illustrates an exemplary drawing a user has made on the CAD canvas by tracing the outside shape of one of the automobile pictures and the tree picture, which can be seen through the transparent canvas.

FIG. 8 illustrates the exemplary drawing made by the user now on the opaque canvas by itself.

FIG. 9 illustrates a flow chart of an exemplary method for a graphical user interface for a drafting software configured to run on a computer system including a display.

FIG. 10 illustrates a block diagram of an exemplary machine on which a drafting software including a graphical user interface may run.

### DETAILED DESCRIPTION

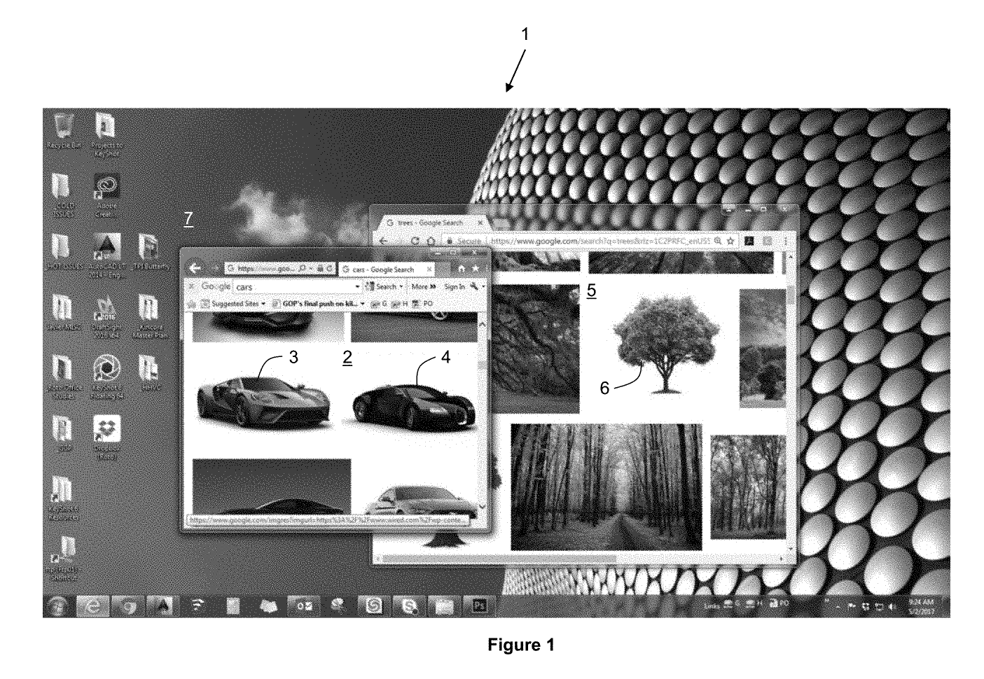

FIG. 1 illustrates an exemplary graphical user interface (GUI) 1 that may be associated with, for example, Microsoft® Windows®. The GUI 1 may include a window 2 on which two pictures 3, 4 of automobiles are displayed and a window 5 on which a tree 6 is displayed. The GUI 1 may also include a background or desktop 7. The GUI 1 may be used to display windows such as the windows 2 and 5, and, within windows, objects and work surfaces such as, for example, the work surface that resembles a piece of paper in Microsoft® Word's print view and the work surface commonly known as a canvas or paper space that resembles a drawing canvas in computer aided design (CAD) drawing software such as Adobe Illustrator.

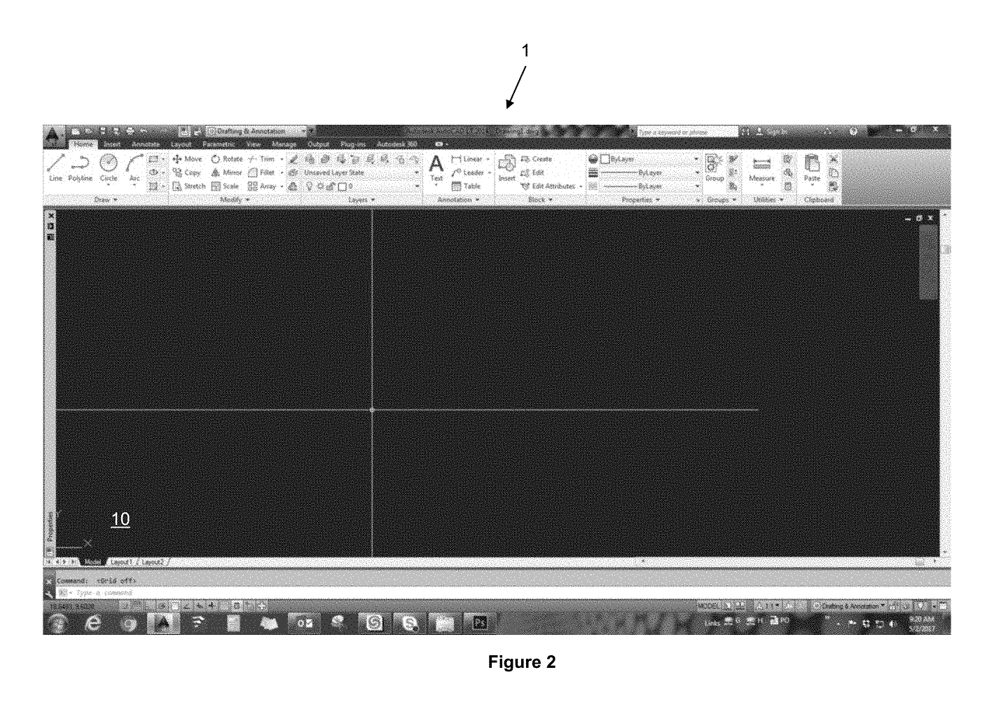

FIG. 2 illustrates a prior art CAD canvas 10. Drawing canvas in CAD software receive and display on the canvas user drawing input such as, for example, user drawing input entered by a user by using a mouse, a drawing pen on the computer screen, etc. The canvas 10 resembles a painter's canvas on which the artist or designer may draw. Such drawing canvas are also known as design space, drawing space, model space, paper space, etc.

As seen in FIG. 2, the canvas 10 is opaque. Therefore, the windows 2 and 5, and the background 7 that are behind the canvas 10 cannot be seen through the canvas 10 in the GUI 1. Prior art canvas may be set to different colors such as white, black, and every other color in between but they are generally opaque.

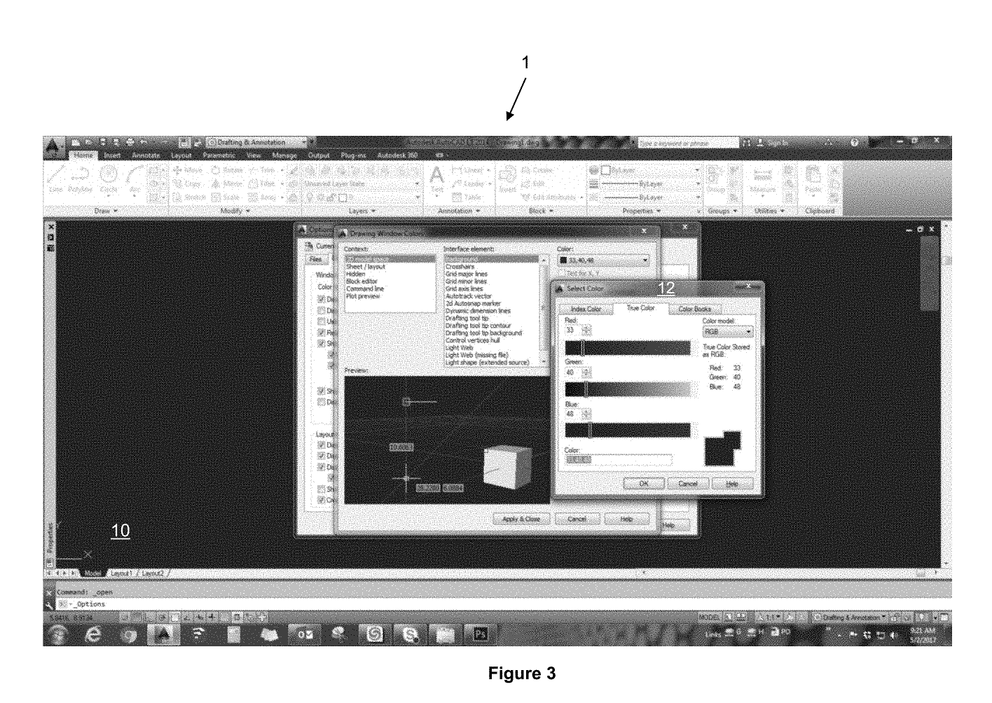

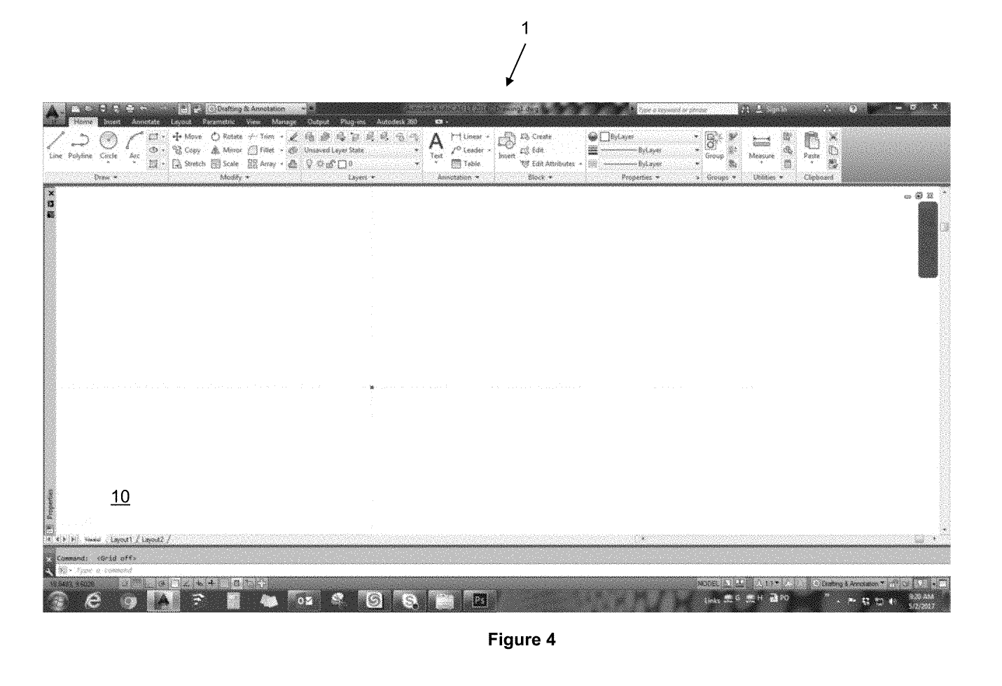

FIG. 3 illustrates an exemplary menu window 12 for a prior art CAD software. As can be seen from FIG. 3, the menu window 12, again, allows for the canvas 10 to be set to different colors such as black or white. In FIG. 3, the canvas 10 is set to black. In FIG. 4 the canvas 10 has now been set to white. In each case, however, the canvas 10 remains opaque.

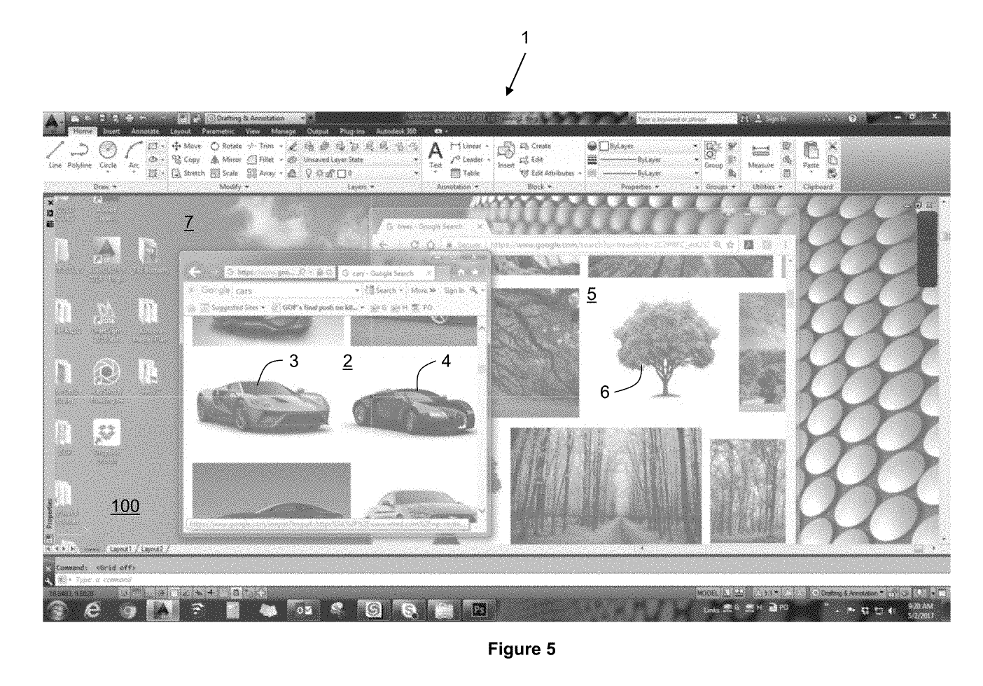

FIG. 5 illustrates one embodiment of the present invention, a canvas 100 that is semi-transparent. Windows 2, 5 and the background 7 that are behind the canvas 100 are now visible through the canvas 100. Unlike the canvas 10 of the previous figures, which was opaque, the semi-transparent canvas 100 allows for windows and objects such as the automobiles 3, 4 and the tree 6 behind the canvas 100 to be seen through the canvas 100.

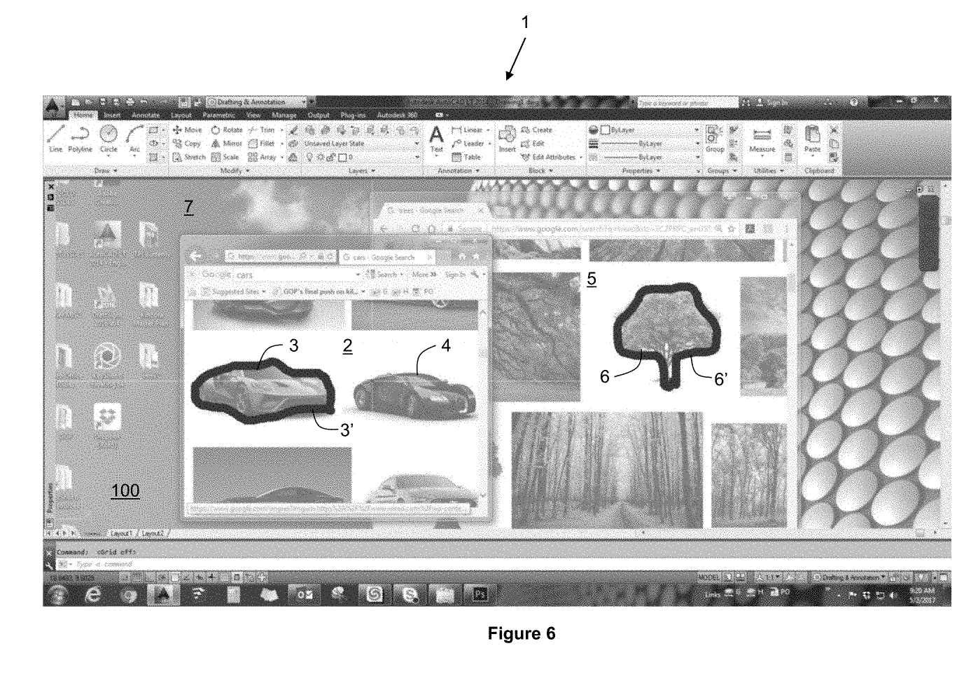

FIG. 6 illustrates the semi-transparent canvas 100. A user has sketched the automobile 3 and the tree 6 on the canvas 100 by tracing the outside shape of the automobile 3 and the tree 6 on to the canvas 100 to produce the drawings 3′ and 6′. Tracing the automobile 3 and the tree 6 on to the canvas 100 is possible because those objects can be seen through the semi-transparent canvas 100.

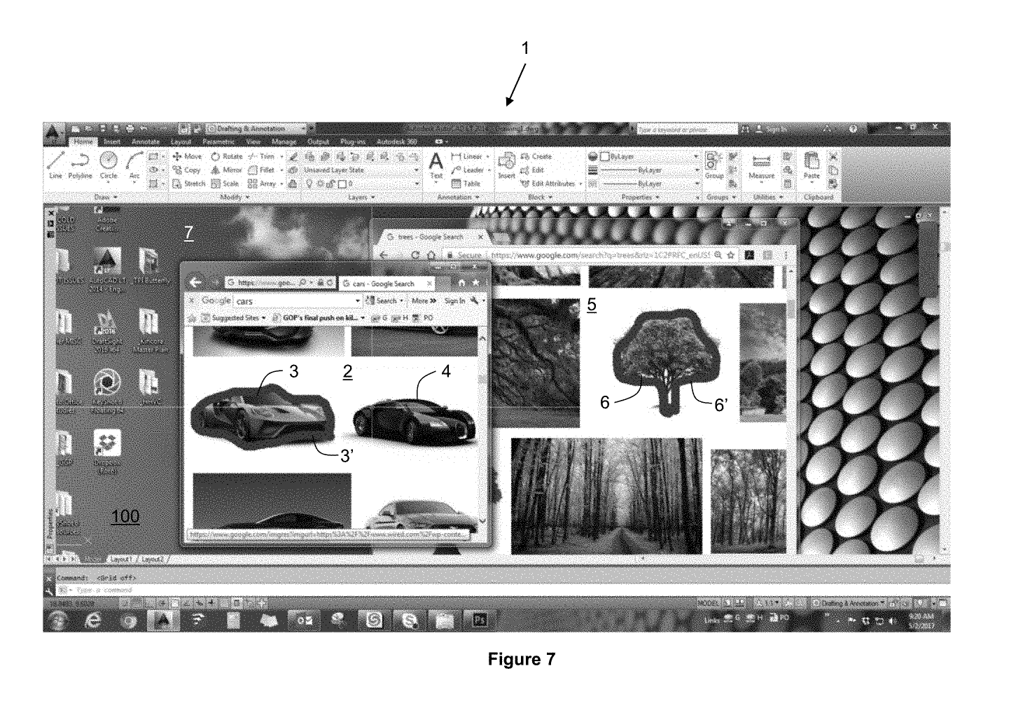

FIG. 7 is similar to FIG. 6 except that it illustrates the canvas 100 as a transparent canvas. Because the canvas 100 is transparent, a user may sketch the automobile 3 and the tree 6 on to the canvas 100 by tracing the outside shape of the automobile 3 and the tree 6 on to the canvas 100 to produce the drawings 3′ and 6′. Tracing the automobile 3 and the tree 6 on to the canvas 100 is possible because those objects can be seen through the fully transparent canvas 100.

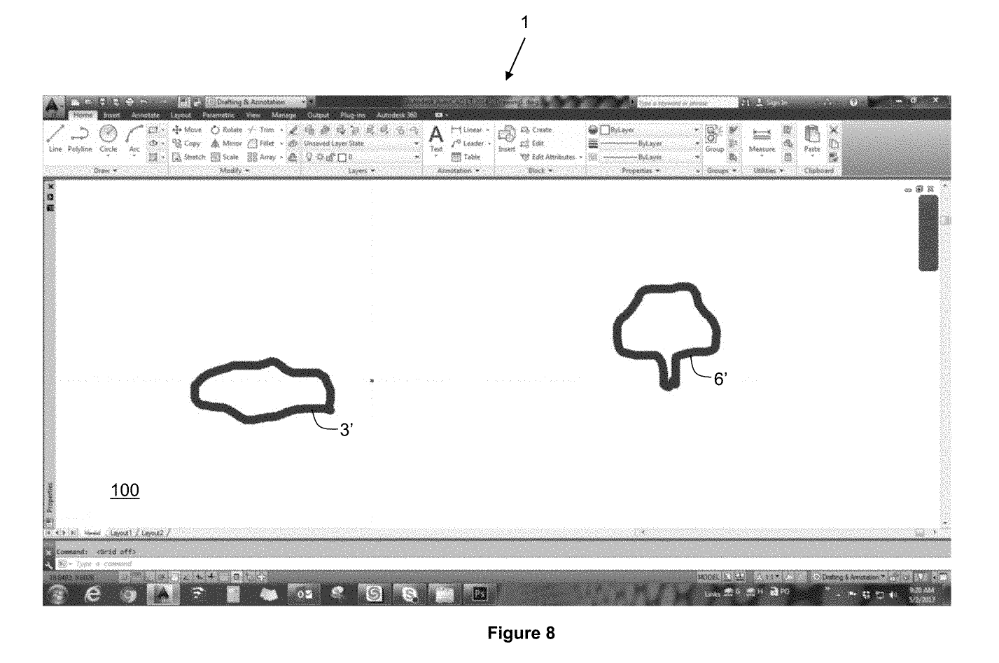

FIG. 8 illustrates the canvas 100 reset to opaque and including the sketches of the automobile 3 and the tree 6. Upon completing tracing of objects seen through the semi-transparent or transparent canvas 100, a user may set the canvas 100 to opaque (white in the example of FIG. 8). Windows and objects behind the canvas 100 can no longer be seen through the canvas 100. The drawings of the automobile 3′ and the tree 6′, however, remain visible on the opaque canvas 100.

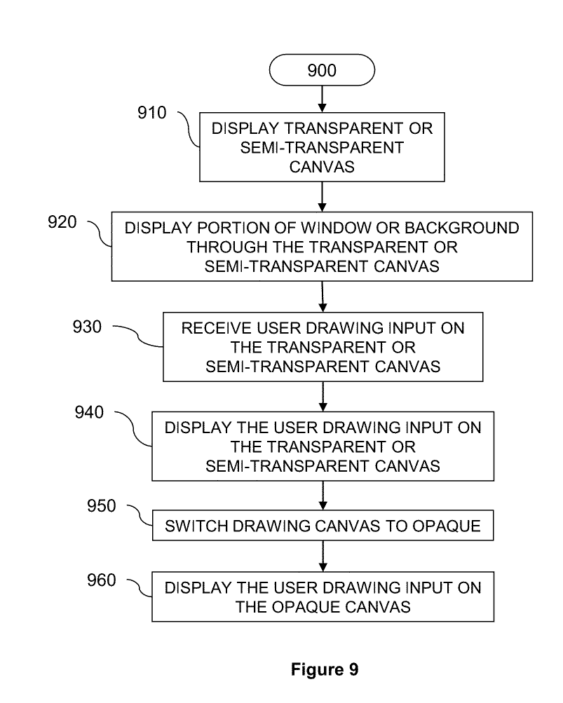

FIG. 9 illustrates a flow diagram for an exemplary method 900 for a graphical user interface (GUI) for a drafting software configured to run on a computer system including a display on which the GUI is displayed. At 910, the method 900 includes displaying as part of a window a transparent or semi-transparent drawing canvas configured to receive and display thereon user drawing input. At 920, the method 900 may also include displaying through the transparent or semi-transparent drawing canvas at least a portion of a background or second window above which the window overlays on the GUI. Since the graphic is displayed through the transparent or semi-transparent drawing canvas, the graphic is traceable by a user onto the drawing canvas.

At 930, the method 900 may include receiving user drawing input on the transparent or semi-transparent drawing canvas by use of a computer input device such as, for example, a stylus, a digital pen, a mouse, etc. If the user traces the graphic visible through the transparent or semi-transparent drawing canvas, the user drawing input includes a facsimile of the graphic as traced on the transparent or semi-transparent drawing canvas. At 940, the method 900 may include displaying the user drawing input on the transparent or semi-transparent drawing canvas such as, for example, displaying the user-drawn facsimile of the graphic on the transparent or semi-transparent drawing canvas.

At 950, the method 900 may include receiving user instructions to switch the drawing canvas from transparent or semi-transparent to opaque. The user may switch the canvas from transparent or semi-transparent to opaque and from opaque to transparent or semi-transparent. And at 960, the method 900 may include displaying the user input such as, for example, the facsimile of the graphic on the now-opaque drawing canvas.

While FIG. 9 illustrates various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other example methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagram, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

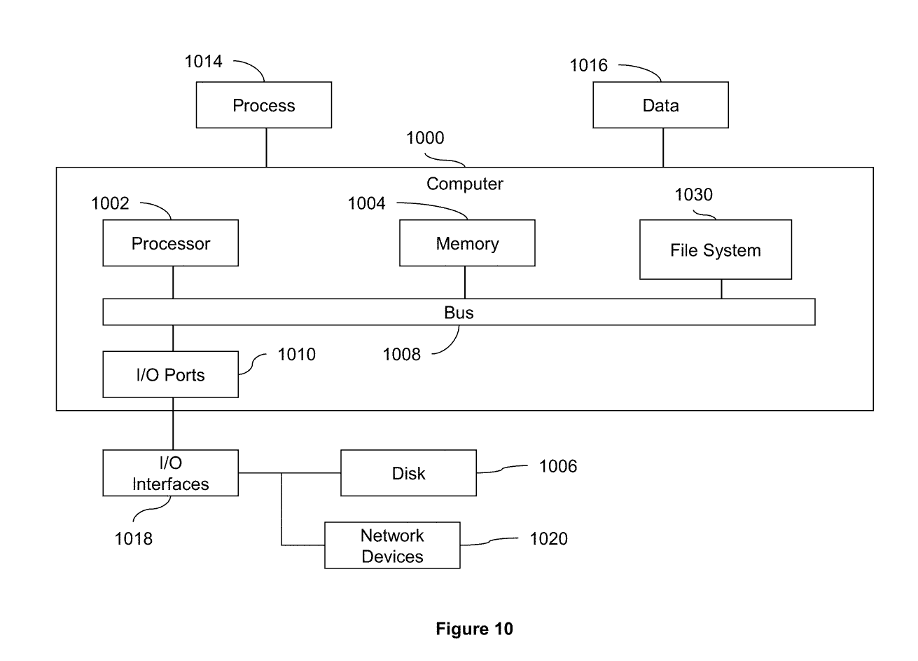

FIG. 10 illustrates a block diagram of an exemplary machine or computer circuit 1000 for a CAD system or on which CAD software may run including the transparent or semi-transparent canvas 100. The machine 1000 may include a processor 1002, a memory 1004, database 1016, and I/O Ports 1010 operably connected by a bus 1008. In one example, the machine 1000 may receive or transmit input or output signals via, for example, I/O Ports 1010 or I/O Interfaces 1018. Thus, the CAD system described above including the transparent or semi-transparent canvas 100 may be implemented in machine 1000 as hardware, firmware, software, or a combination thereof and, thus, the machine 1000 and its components may provide means for performing functions described herein as performed by the CAD system.

The processor 1002 can be a variety of various processors including dual microprocessor and other multi-processor architectures. The memory 1004 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 1006 may be operably connected to the machine 1000 via, for example, an I/O Interfaces (e.g., card, device) 1018 and an I/O Ports 1010. The disk 1006 can include, but is not limited to, devices like a magnetic disk drive, a solid state disk drive, a floppy disk drive, a tape drive, a Zip drive, a flash memory card, or a memory stick. Furthermore, the disk 1006 can include optical drives like a CD-ROM, a CD recordable drive (CD-R drive), a CD rewriteable drive (CD-RW drive), or a digital video ROM drive (DVD ROM). The memory 1004 can store processes 1014 or data 1016, for example. The disk 1006 or memory 1004 can store an operating system that controls and allocates resources of the machine 1000.

The bus 1008 can be a single internal bus interconnect architecture or other bus or mesh architectures. While a single bus is illustrated, it is to be appreciated that machine 1000 may communicate with various devices, logics, and peripherals using other busses that are not illustrated (e.g., PCIE, SATA, Infiniband, 1394, USB, Ethernet). The bus 1008 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The machine 1000 may interact with input/output devices via I/O Interfaces 1018 and I/O Ports 1010. Input/output devices can include, but are not limited to, a keyboard, a microphone, a pointing and selection device, cameras, video cards, displays, disk 1006, network devices 1020, and the like. The I/O Ports 1010 can include but are not limited to, serial ports, parallel ports, and USB ports.

The machine 1000 can operate in a network environment and thus may be connected to network devices 1020 via the I/O Interfaces 1018, or the I/O Ports 1010. Through the network devices 1020, the machine 1000 may interact with a network. Through the network, the machine 1000 may be logically connected to remote computers. The networks with which the machine 1000 may interact include, but are not limited to, a local area network (LAN), a wide area network (WAN), and other networks. The network devices 1020 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 1020 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

As used herein, an “operable connection” or “operable coupling,” or a connection by which entities are “operably connected” or “operably coupled” is one in which the entities are connected in such a way that the entities may perform as intended. An operable connection may be a direct connection or an indirect connection in which an intermediate entity or entities cooperate or otherwise are part of the connection or are in between the operably connected entities. In the context of signals, an “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal,” as used herein, includes but is not limited to one or more electrical or optical signals, analog or digital signals, data, one or more computer or processor instructions, messages, a bit or bit stream, or other means that can be received, transmitted, or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A graphical user interface (GUI) for a drafting software configured to run on a computer system including a display on which the GUI is displayed, the GUI comprising:
a window including a drawing canvas configured to receive and display thereon user drawing input and further configured to be made transparent or semi-transparent such that at least a portion of a background or second window above which the window overlays is visible through the drawing canvas.

2. The GUI of claim 1, wherein the transparent or semi-transparent drawing canvas is configured to receive and display thereon the user drawing input such that a graphic displayed on the background or second window and that is visible through the transparent or semi-transparent drawing canvas is traceable by a user onto the drawing canvas by using a computer input device.

3. The GUI of claim 2, wherein the window comprises:
a command area configured to receive user instructions including a user instruction for switching the drawing canvas from opaque to transparent or semi-transparent.

4. The GUI of claim 2, wherein the window comprises:
a command area configured to receive user instructions including a user instruction for switching the drawing canvas from transparent or semi-transparent to opaque, wherein the opaque drawing canvas is configured to display thereon the user drawing input such that the graphic traced by the user onto the drawing canvas by using the computer input device is displayed on the opaque drawing canvas while the background or second window is no longer visible through the drawing canvas.

5. A window for a drafting software configured to run on a computer system including a display, the window comprising:
a drawing canvas configured to receive and display user drawing input and further configured to be made transparent or semi-transparent such that a background or second window above which the window overlays is visible through the drawing canvas.

6. The window of claim 5, wherein the transparent or semi-transparent drawing canvas is configured to receive and display thereon the user drawing input such that a graphic displayed on the background or second window and that is visible through the transparent or semi-transparent drawing canvas is traceable by a user onto the drawing canvas by using a computer input device.

7. The window of claim 6, comprising:
a command graphical user interface area configured to receive user instructions including a user instruction for switching the drawing canvas from opaque to transparent or semi-transparent.

8. A computer-aided drafting (CAD) system, comprising:
a graphical user interface (GUI) area including a drawing area configured to receive and display thereon user drawing input and further configured to be made transparent or semi-transparent such that at least a portion of a background or window above which the GUI area is disposed is visible through the transparent or semi-transparent drawing area.

9. The CAD system of claim 8, wherein the transparent or semi-transparent drawing area is configured to receive and display thereon the user drawing input such that a graphic, visible through the transparent or semi-transparent drawing area, is traceable by a user onto the drawing area by using a computer input device.

10. The CAD system of claim 9, wherein the GUI area comprises:
a command area configured to receive user input including a user instruction for switching the drawing area from opaque to transparent or semi-transparent.

11. A method for a graphical user interface (GUI) for a drafting software configured to run on a computer system including a display on which the GUI is displayed, the method comprising:
displaying as part of a window a transparent or semi-transparent drawing canvas configured to receive and display thereon user drawing input; and
displaying through the transparent or semi-transparent drawing canvas at least a portion of a background or second window above which the window overlays on the GUI.

12. The method of claim 11, comprising:
receiving the user drawing input on the transparent or semi-transparent drawing canvas.

13. The method of claim 11, comprising
receiving the user drawing input on the transparent or semi-transparent drawing canvas; and
displaying the user drawing input on the transparent or semi-transparent drawing canvas.

14. The method of claim 11, comprising
displaying through the transparent or semi-transparent drawing canvas a graphic displayed on the background or the second window above which the window overlays on the GUI such that the graphic is traceable by a user onto the drawing canvas by using a computer input device;
receiving the user drawing input including a facsimile of the graphic traced on the transparent or semi-transparent drawing canvas; and
displaying the facsimile of the graphic on the transparent or semi-transparent drawing canvas.

15. The method of claim 11, comprising
displaying through the transparent or semi-transparent drawing canvas a graphic displayed on the background or the second window above which the window overlays on the GUI;
receiving the user drawing input including a facsimile of the graphic traced on the transparent or semi-transparent drawing canvas by a user using a computer input device;
receiving user instructions to switch the drawing canvas from transparent or semi-transparent to opaque;
displaying the facsimile of the graphic on the opaque drawing canvas.

16. A non-transitory computer-readable medium having stored therein a program that when run in a computer causes the computer to perform a method comprising:
displaying as part of a graphical user interface area a transparent or semi-transparent drawing area configured to receive and display thereon user drawing input; and
displaying through the transparent or semi-transparent drawing area at least a portion of a background or window above which the graphical user interface area is disposed.

17. The method of claim 16, comprising:
receiving the user drawing input on the transparent or semi-transparent drawing area.

18. The method of claim 16, comprising
receiving the user drawing input on the transparent or semi-transparent drawing area; and
displaying the user drawing input on the transparent or semi-transparent drawing area.

19. The method of claim 16, comprising
displaying through the transparent or semi-transparent drawing area a graphic displayed on the background or the window such that the graphic is traceable by a user onto the drawing area by using a computer input device;
receiving the user drawing input including a facsimile of the graphic traced on the transparent or semi-transparent drawing area; and
displaying the facsimile of the graphic on the transparent or semi-transparent drawing area.

20. The method of claim 16, comprising
displaying through the transparent or semi-transparent drawing area a graphic displayed on the background or the window;
receiving the user drawing input including a facsimile of the graphic traced on the transparent or semi-transparent drawing area by a user using a computer input device;
receiving user instructions to switch the drawing area from the transparent or semi-transparent drawing area to an opaque drawing area; and
displaying the facsimile of the graphic on the opaque drawing area.
